(19) United States
(12) Patent Application Publication
(10) Pub. No.: US 2003/0221194 A1
(43) Pub. Date: Nov. 27, 2003

(54) Fast-advance while recording on-demand content

(76) Inventors: Balaji Thiagarajan, San Jose, CA (US); Arvind Kumar Peechara, Sunnyvale, CA (US)

Correspondence Address: LEE & HAYES PLLC, 421 W RIVERSIDE AVENUE SUITE 500, SPOKANE, WA, 99201

(21) Appl. No.: 10/154,763

(22) Filed: May 23, 2002

(51) Int. Cl. H04N 5/445; H04N 7/173

(52) U.S. Cl. 725/55; 725/100; 725/131

(57) ABSTRACT

A digital video recording system receives a first stream of on-demand video content and can both record the video content and route the video content for viewing on a display device. In response to a viewer request to fast-advance the video content display, the digital video recording system can request a second stream of the on-demand video content and route the second video content for fast-advance display on the display device while continuing to record the first video content without interruption and without a change in the speed at which the video content is recorded.

### TECHNICAL FIELD

This invention relates to television entertainment and information architectures and, in particular, to fast-advancing a display of on-demand content while recording the on-demand content at a viewable playback speed.

### BACKGROUND

Digital video recorders are implemented as client devices to receive video content in the form of on-demand entertainment, such as movies, and to receive broadcast and/or interactive television entertainment and information. A digital video recorder includes a hard disk memory so that a viewer can record the video content and other content of interest to the viewer. A digital video recorder also provides a viewer with convenient functionality, such as the ability to pause the broadcast of a television program and return to watch the video or program, while still in progress, from the point at which it was paused.

To implement this functionality, a digital video recorder includes a pause buffer to record the most recent segment of a paused broadcast program or on-demand video, and to playback the program or video for viewing from the beginning of the pause event when a viewer returns to continue watching the program or video. A pause buffer is typically configured as a circular, or ring, buffer on the hard disk memory and the amount of time which a television program can be delayed is dependent upon how much storage space is allocated for the pause buffer. When a pause buffer reaches capacity, such as after thirty minutes for example, the content corresponding to the beginning of a pause event will be written over. This example pause buffer is a sliding thirty minute recorder of the most recently displayed content.

When a viewer requests an on-demand video, such as a movie, from a video on-demand (VOD) provider, the video content is received with a client device, such as a digital video recorder, and can be routed through a pause buffer to both display the movie on a television and record the movie in the hard disk memory. A feature of on-demand content is that the viewer can request to jump ahead in the movie, such as to the end, and see the outcome without having to watch the entire movie. However, if the viewer is also recording the movie while watching it, and initiates a fast-forward command, the segment of the movie that was fast-forwarded over will be fast-forward recorded in the hard disk memory and can not be played back at a viewable playback speed for later viewing. The segment of the movie will be fast-forward recorded because the fast-forward command initiated by the viewer is sent to the video on-demand provider, or server, which then provides the video content as a fast-forward stream that is received by the client device and recorded as a fast-forward content stream.

Accordingly, for television-based entertainment and information systems, there is a need for a technique to fast-forward and fast-rewind the display of requested on-demand video content while also recording the on-demand video content at a viewable playback speed as it is being received.

### SUMMARY

A digital video recording system receives a first stream of on-demand video content and can both record the video content and route the video content for viewing on a display device. In response to a viewer request to fast-advance the video content display, the digital video recording system can request a second stream of the on-demand video content and route the second video content for fast-advance display on the display device while continuing to record the first video content without interruption and without a change in the speed at which the video content is recorded. In an implementation, the digital video recording system includes a short-term content buffer that maintains a recent segment of the first video content and requests the second stream of the on-demand video content when the fast-advance request exceeds the extent of the buffered content.

### BRIEF DESCRIPTION OF THE DRAWINGS

The same numbers are used throughout the drawings to reference like features and components.

FIG. 1 illustrates an exemplary system architecture in which systems and methods to fast-advance on-demand content while recording the on-demand content can be implemented.

FIG. 2 illustrates an example client device, a television, and various input devices that interact with the client device.

FIG. 3 illustrates various components of an exemplary digital video recording system that includes an example client device.

FIG. 4 illustrates various components of an exemplary digital video recorder to enable fast-advance while recording on-demand content.

FIG. 5 is a flow diagram that illustrates a method for fast-advance while recording on-demand content.

### DETAILED DESCRIPTION

A digital video recording system receives a first stream of on-demand video content, such as a movie, when a viewer requests the movie from a video on-demand (VOD) provider. The movie can both be recorded on a hard disk memory in the digital video recorder and can be routed for viewing on a display device, such as a television, connected to the digital video recorder. In response to a viewer request to fast-forward or fast-rewind the movie displayed on the television, the digital video recording system can request a second stream of the on-demand video content from the video on-demand provider and route the second video content for fast-advance display on the television while continuing to record the movie from the first stream of video content without interruption and without a change in the speed at which the video content is recorded.

The following discussion is directed to television-based entertainment and information systems, such as interactive TV networks, cable networks that utilize electronic program guides, and Web-enabled TV networks. Client devices in such systems include full-resource clients with substantial memory and processing resources, such as TV-enabled personal computers and digital video recorders equipped with hard-disks. While aspects of the described systems and methods can be used in any of these systems and for any types of client devices, they are described in the context of the following exemplary environment.

Exemplary System Architecture

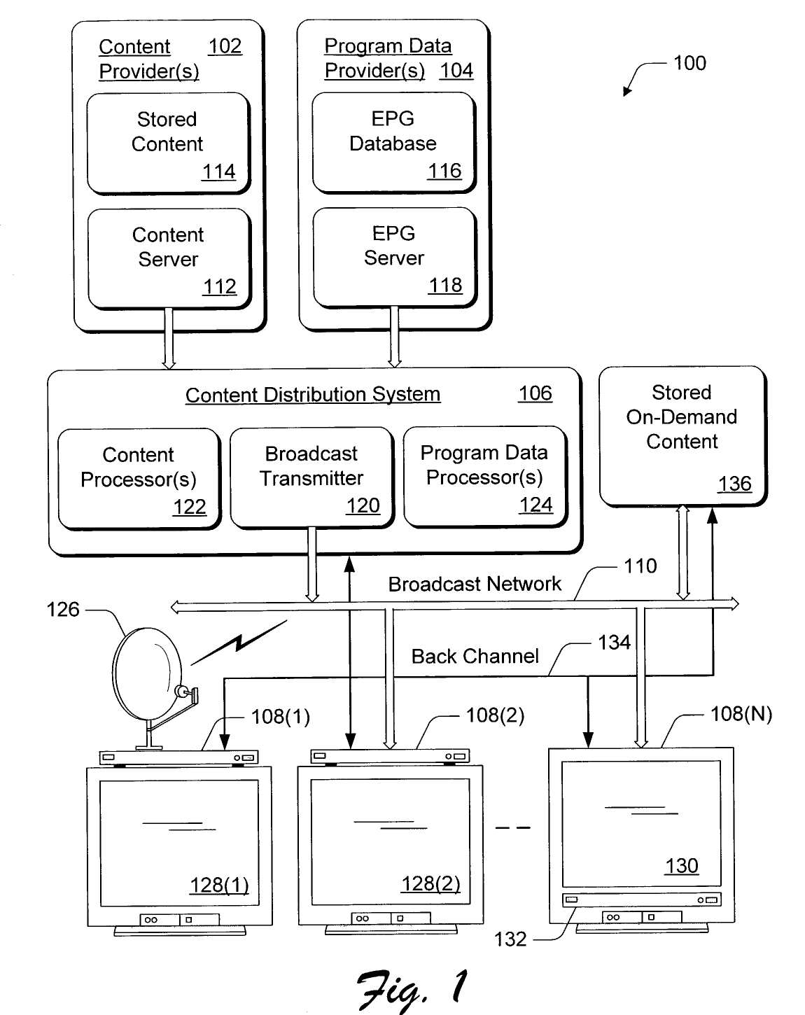

FIG. 1 illustrates an exemplary television entertainment system 100 that is an architecture in which a technique can be implemented to fast-advance the display of on-demand video content while also recording the on-demand video content at a viewable playback speed as it is being received. System 100 facilitates distribution of content and program data to multiple viewers, and includes one or more content providers 102, one or more program data providers 104, a content distribution system 106, and multiple client devices 108(1), 108(2), . . . , 108(N) coupled to the content distribution system 106 via a broadcast network 110.

Content provider 102 includes a content server 112 and stored content 114, such as movies, television programs, commercials, music, and similar audio and/or video content. Content server 112 controls distribution of the stored content 114 from content provider 102 to the content distribution system 106. Additionally, content server 112 controls distribution of live content (e.g., content that was not previously stored, such as live feeds) and/or content stored at other locations to the content distribution system 106. Program data provider 104 includes an electronic program guide (EPG) database 116 and an EPG server 118. The EPG database 116 stores electronic files of program data which is used to generate an electronic program guide (or, “program guide”). Program data (or, “EPG data”) includes program titles, ratings, characters, descriptions, actor names, station identifiers, channel identifiers, schedule information, and so on.

The EPG server 118 processes the program data prior to distribution to generate a published version of the program data which contains programming information for all channels for one or more days. The processing may involve any number of techniques to reduce, modify, or enhance the program data. Such processes might include selection of content, content compression, format modification, and the like. The EPG server 118 controls distribution of the published version of the program data from program data provider 104 to the content distribution system 106 using, for example, a file transfer protocol (FTP) over a TCP/IP network (e.g., Internet or an Intranet). Further, the published version of the program data can be transmitted from program data provider 104 via a satellite directly to a client device 108.

Content distribution system 106 includes a broadcast transmitter 120, one or more content processors 122, and one or more program data processors 124. Broadcast transmitter 120 broadcasts signals, such as cable television signals, across broadcast network 110. Broadcast network 110 can include a cable television network, RF, microwave, satellite, and/or data network, such as the Internet, and may also include wired or wireless media using any broadcast format or broadcast protocol. Additionally, broadcast network 110 can be any type of network, using any type of network topology and any network communication protocol, and can be represented or otherwise implemented as a combination of two or more networks.

A content processor 122 processes the content received from content provider 102 prior to transmitting the content across broadcast network 110. Similarly, a program data processor 124 processes the program data received from program data provider 104 prior to transmitting the program data across broadcast network 110. A particular content processor 122 may encode, or otherwise process, the received content into a format that is understood by the multiple client devices 108(1), 108(2), . . . , 108(N) coupled to broadcast network 110. Although FIG. 1 shows a single content provider 102, a single program data provider 104, and a single content distribution system 106, exemplary system 100 can include any number of content providers and/or program data providers coupled to any number of content distribution systems.

Content distribution system 106 is representative of a headend service, or network operator, that provides EPG data, as well as content, to multiple subscribers. Each content distribution system 106 may receive a slightly different version of the program data that takes into account different programming preferences and lineups. The EPG server 118 creates different versions of EPG data (e.g., different versions of a program guide) that include those channels of relevance to respective headend services, and the content distribution system 106 transmits the EPG data to the multiple client devices 108(1), 108(2), . . . , 108(N). In one implementation, for example, content distribution system 106 utilizes a carousel file system to repeatedly broadcast the EPG data over an out-of-band (OOB) channel to the client devices 108.

Client devices 108 can be implemented in a number of ways. For example, a client device 108(1) receives broadcast content from a satellite-based transmitter via a satellite dish 126. Client device 108(1) is also referred to as a set-top box or a satellite receiving device. Client device 108(1) is coupled to a television 128(1) for presenting the content received by the client device (e.g., audio data and video data), as well as a graphical user interface. A particular client device 108 can be coupled to any number of televisions 128 and/or similar devices that can be implemented to display or otherwise render content. Similarly, any number of client devices 108 can be coupled to a single television 128.

Client device 108(2) is also coupled to receive broadcast content from broadcast network 110 and provide the received content to associated television 128(2). Client device 108(N) is an example of a combination television 130 and integrated set-top box 132. In this example, the various components and functionality of the set-top box are integrated into the television, rather than using two separate devices. The set-top box integrated into the television can receive broadcast signals via a satellite dish (similar to satellite dish 126) and/or via broadcast network 110. In alternate implementations, client devices 108 may receive broadcast signals via the Internet or any other broadcast medium, such as back channel 134 which can be implemented as an Internet protocol (IP) connection using a modem connection and conventional telephone line, for example. Further, back channel 134 provides an alternate communication link between each of the client devices 108, and between the client devices 108 and the content distribution system 106.

Each client device 108 can run an electronic program guide (EPG) application that utilizes the program data. An EPG application enables a television viewer to navigate through an onscreen program guide and locate television shows and other broadcast content of interest to the viewer. With an EPG application, the television viewer can look at schedules of current and future programming, set reminders for upcoming programs, and/or enter instructions to record one or more television shows.

The exemplary system 100 also includes stored on-demand content 136, such as video on-demand (VOD) movie content. The stored on-demand content 136 can be viewed with a television 128 via a client device 108 through an onscreen movie guide, for example, and a viewer can enter instructions to stream a particular movie, or other stored content, down to a corresponding client device 108.

Exemplary Client Device

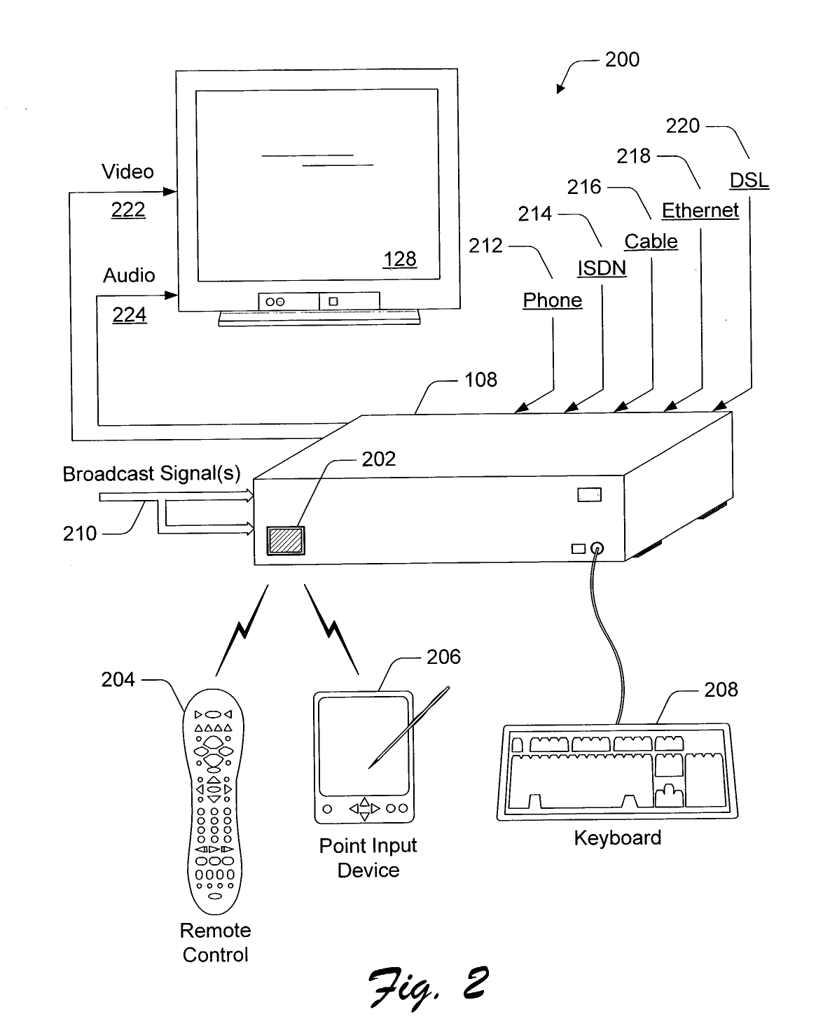

FIG. 2 illustrates an exemplary implementation 200 of a client device 108 shown as a standalone unit that connects to a television 128. Client device 108 can be implemented in any number of embodiments, including as a set-top box, a satellite receiver, a TV recorder with a hard disk, a digital video recorder (DVR) and playback system, a game console, an information appliance, and so forth.

Client device 108 includes a wireless port 202, such as an infrared (IR) or Bluetooth wireless port, for receiving wireless communications from a remote control device 204, a handheld input device 206, or any other wireless device, such as a wireless keyboard. Handheld input device 206 can be a personal digital assistant (PDA), handheld computer, wireless phone, or the like. Additionally, a wired keyboard 208 can be coupled to communicate with client device 108. In alternate embodiments, remote control device 204, handheld device 206, and/or keyboard 208 may use an RF communication link or other mode of transmission to communicate with client device 108.

Client device 108 receives one or more broadcast signals 210 from one or more broadcast sources, such as from a satellite or from a broadcast network, such as broadcast network 110 (FIG. 1). Client device 108 includes hardware and/or software for receiving and decoding broadcast signal 210, such as an NTSC, PAL, SECAM, or other TV system video signal. Client device 108 also includes hardware and/or software for providing the user with a graphical user interface by which the user can, for example, access various network services, configure the client device 108, and perform other functions.

Client device 108 can communicate with other devices via one or more connections including a conventional telephone line 212, an ISDN link 214, a cable link 216, an Ethernet link 218, a DSL link 220, and the like. Client device 108 may use any one or more of the various communication links 212-220 at a particular instant to communicate with any number of other devices.

Client device 108 generates video signal(s) 222 and audio signal(s) 224, both of which are communicated to television 128. The video signals and audio signals can be communicated from client device 108 to television 128 via an RF (radio frequency) link, S-video link, composite video link, component video link, or other communication link. Although not shown in FIG. 2, client device 108 may include one or more lights or other indicators identifying the current status of the device. Additionally, the client device may include one or more control buttons, switches, or other selectable controls for controlling operation of the device.

Exemplary Digital Video Recording System

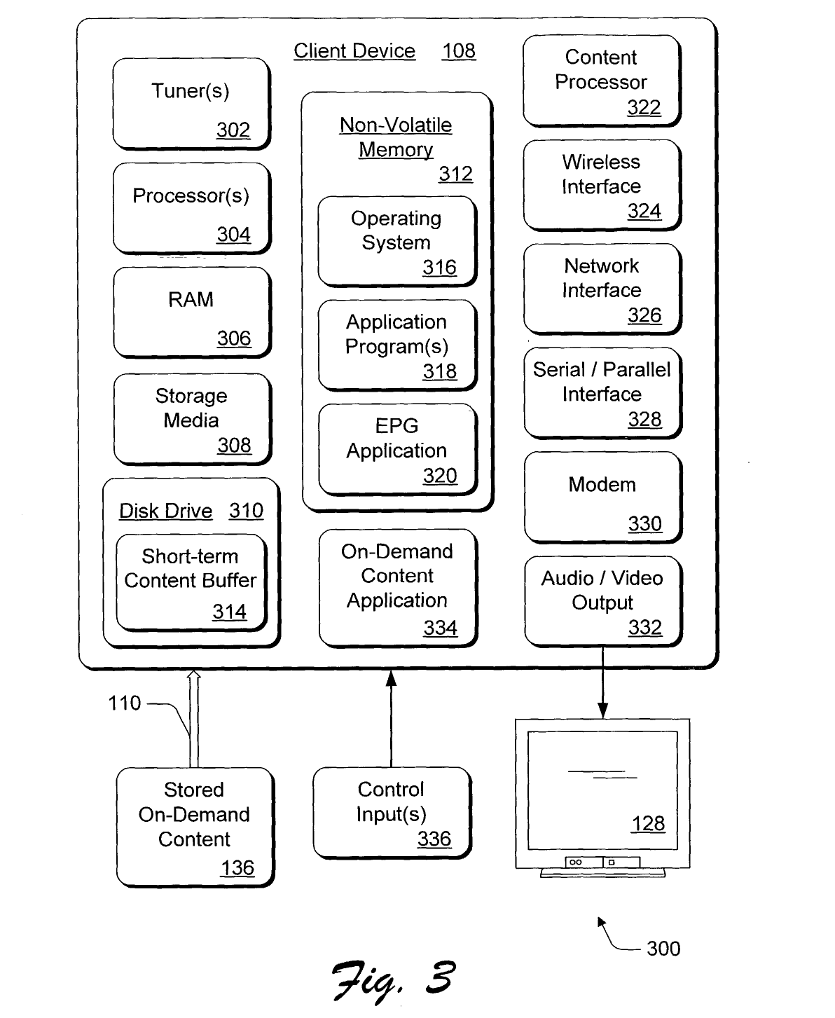

FIG. 3 illustrates an exemplary digital video recording system 300 that includes selected components of television system 100, such as an exemplary client device 108 as shown in FIGS. 1 and 2, and a television 128. Client device 108 includes components to implement a digital video recording system and techniques to fast-forward and/or fast rewind a display of on-demand content while recording the on-demand content.

Client device 108 includes one or more tuners 302 which are representative of one or more in-band tuners that tune to various frequencies or channels to receive television signals, as well as an out-of-band tuner that tunes to the broadcast channel over which the EPG data is broadcast to client device 108. Client device 108 also includes one or more processors 304 which process various instructions to control the operation of client device 108 and to communicate with other electronic and computing devices.

Client device 108 can be implemented with one or more memory components, examples of which include a random access memory (RAM) 306, a mass storage media 308, a disk drive 310, and a non-volatile memory 312 (e.g., ROM, Flash, EPROM, EEPROM, etc.). The memory components (e.g., RAM 306, storage media 308, disk drive 310, and non-volatile memory 312) store various information and/or data such as received content, EPG data, configuration information for client device 108, and/or graphical user interface information. Further, disk drive 310 includes a portion of memory allocated as a short-term content buffer 314 which maintains segments of stored on-demand content 136 received via broadcast network 110. The short-term content buffer 314 maintains the most recent segment(s) of a paused broadcast program or segments of a received on-demand video.

An operating system 316 and one or more application programs 318 can be stored in non-volatile memory 312 and executed on a processor 304 to provide a runtime environment. A runtime environment facilitates extensibility of client device 108 by allowing various interfaces to be defined that, in turn, allow application programs 318 to interact with client device 108. The application programs 318 that may be implemented in client device 108 can include a browser to browse the Web (e.g., “World Wide Web”), an email program to facilitate electronic mail, a video recorder application or component to facilitate storing received content on disk drive 310 for example, and so on. An EPG application 320 is stored in memory 312 to operate on the EPG data and generate a program guide. Client device 108 can also include other components pertaining to a television entertainment system which are not illustrated in this example. For instance, client device 108 can include a user interface application and user interface lights, buttons, controls, and the like to facilitate viewer interaction with the device.

Client device 108 also includes a content processor and/or decoder 322 to process and decode a broadcast video signal, such as an NTSC, PAL, SECAM, or other TV system video signal. Content processor 322 can also include a video decoder and/or additional processors to receive, decode, and/or process video content received from content distribution system 106 (e.g., a network operator). For example, content processor 322 may include an MP3 or MPEG-2 (Moving Pictures Experts Group) decoder that decodes MPEG-encoded video and advertisement content. MPEG-2 supports a variety of audio/video formats, including legacy TV, HDTV (high-definition television), DVD (digital versatile disc), and five-channel surround sound.

Typically, video content includes video data and audio data that corresponds to the video data. Content processor 322 generates video and/or display content that is formatted for display on display device 128, and generates decoded audio data that is formatted for broadcast by a broadcast device, such as one or more speakers (not shown) in display device 128. Content processor 322 can include a display controller (not shown) that processes the video and/or display content to display corresponding images on display device 128. A display controller can include a microcontroller, integrated circuit, and/or similar video processing component to process the images. It is to be appreciated that the systems and methods described herein can be implemented for any type of encoding format as well as for data and/or content streams that are not encoded.

Client device 108 further includes a wireless interface 324, a network interface 326, a serial and/or parallel interface 328, and a modem 330. Wireless interface 324 allows client device 108 to receive input commands and other information from a user-operated input device, such as from a remote control device or from another IR, Bluetooth, or similar RF input device.

Network interface 326 and serial and/or parallel interface 328 allows client device 108 to interact and communicate with other electronic and computing devices via various communication links. Although not shown, client device 108 may also include other types of data communication interfaces to communicate with other devices. Modem 330 facilitates client device 108 communication with other electronic and computing devices via a conventional telephone line. Client device 108 also includes an audio and/or video output 332 that provides signals to television 128 or to other devices that process and/or display, or otherwise render, the audio and video data.

Client device 108 includes an on-demand content application 334 that manages received on-demand video content 136 which can be maintained in short-term content buffer 314, recorded onto disk drive 310, and/or routed for display on television 128. The on-demand content application 334 can be implemented as a software component that executes on a processor 304 and is stored in non-volatile memory 312. The on-demand content application 334 can also receive viewer commands as control inputs 336, such as from viewer-operated remote control device 204, handheld device 206, and/or keyboard 208. The viewer-inputs can include video display commands such as record, fast-forward, rewind, pause, and the like. The input commands may be input via an RF, IR, Bluetooth, or similar communication link or other mode of transmission to communicate with on-demand content application 334.

Although shown separately, some of the components of client device 108 may be implemented in an application specific integrated circuit (ASIC). Additionally, a system bus (not shown) typically connects the various components within client device 108. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

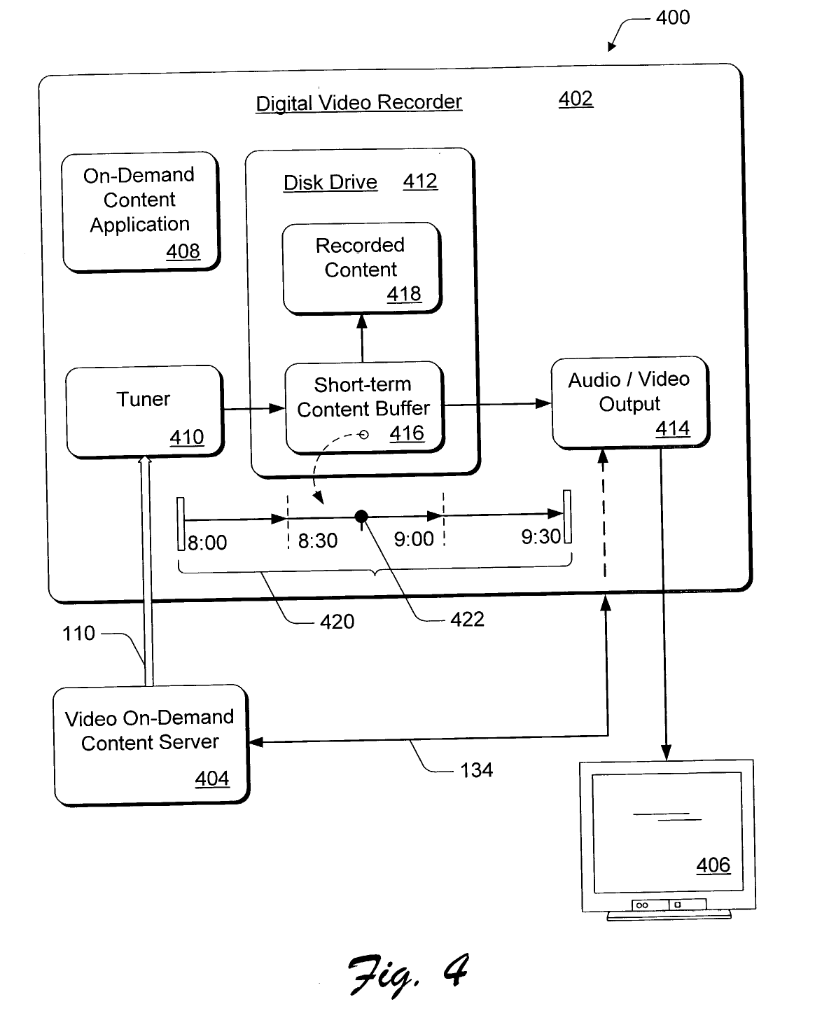

FIG. 4 illustrates a digital video recording system 400 which includes an exemplary digital video recorder 402 to enable fast-advancing a video display of on-demand video content while recording the on-demand video content. The system 400 also includes a video on-demand content server 404, such as may be implemented by a content provider, and includes a display device 406, such as a television.

The digital video recorder 402 includes various components described with reference to exemplary client device 108 shown in FIG. 3, and can include any number and combination of the components to implement digital video recorder 402. In this example, digital video recorder 402 includes an on-demand content application 408, a tuner 410, a disk drive 412, and an audio and/or video output component 414. The disk drive 412 includes a short-term content buffer 416 and recorded content 418.

When a viewer requests to receive a movie, for example, from the video on-demand content server 404, a video content stream is communicated to digital video recorder 402 via broadcast network 110 and received with tuner 410. The video content stream is routed to the short-term content buffer 416 which maintains segments of the video content stream, such as the most recent thirty minutes, for example. A time duration 420 illustrates that a viewer-requested movie is an hour and a half long, from a start time of 8:00 to and end time of 9:30. The example illustrates that a first segment of the movie from the start time of 8:00 to 8:30 has been routed through the short-term content buffer 416 while a next segment of the movie from 8:30 to 9:00 is maintained in short-term content buffer 416. A next segment of the movie from 9:00 until the end of the movie at 9:30 is yet to be received and routed through the short-term content buffer 416.

The video content stream is routed from the short-term content buffer 416 to the audio and/or video output component 414 which communicates the video content to television 406 where the movie is displayed for viewing. Additionally, the video content stream is routed from the short-term content buffer 416 to generate a recording 418 of the movie which can be played back for later viewing.

If the viewer requests to fast-advance the movie being displayed on television 406, such as to jump ahead and see the ending of the movie without having to watch the entire movie, the on-demand content application 408 can request a second input of the same video content from the video on-demand content server 404 so as not to interrupt, or change the speed at which the first video content is being recorded. In a digital video recorder having a short-term content buffer, as is illustrated in this example, the on-demand content application 408 can be configured to request the second video content when the segment of the movie that will be fast-forwarded over is not currently maintained in the short-term content buffer.

For example, if the viewer requests to fast-forward the movie at 8:35 and stops the fast-forward at 8:45, which is within the segment of the movie currently maintained in short-term content buffer 416 (i.e., movie segment 8:30 to 9:00), then the first video content recording will not be interrupted and the speed of the recording will not be changed because of the remaining fifteen minute delay (i.e., 8:45 to the end of the buffered content at 9:00). Thus, a second input of the same video content will not be needed for display to prevent interrupting or altering the recording speed of the first video content, and the fast-forward command is managed within short-term content buffer 416. However, if the viewer requests to fast-forward the movie at 8:35 and stops the fast-forward at 9:15, for example, the on-demand content application 408 will request a second input of the same video content because the fast-forward command exceeds the end of the buffered content at 9:00.

The on-demand content application 408 can be configured with any number of detection policies to determine when to request the second video content input. For example, the second video content input can be requested five minutes before the end of the buffered content, one minute before, and the like. Further, it is to be appreciated that although this discussion is directed to fast-forwarding and recording on-demand content, the described systems and methods are applicable to an implementation for rewinding and recording the on-demand content. For example, if a viewer initiates a rewind command of the movie being displayed, and the viewer requests to rewind past the beginning of the buffered content at 8:30, then the on-demand content application 408 can request a second input of the same video content for display so as to not interrupt or alter the first video content recording.

The on-demand content application 408 can request that the second video content be provided at the same channel frequency that the first video content is received so that the tuner 410 also does not interrupt receiving the first video content that is being recorded. A second video content stream received at the same channel frequency is communicated to digital video recorder 402 via back channel 134 and is routed directly to the audio and/or video output component 414 which communicates the second video content to television 406 where the movie is fast-forward displayed for viewing. Although the first video content is no longer displayed on television 406, the first video content is still received via broadcast network 110 and is still being recorded in disk drive 412 without interruption.

The on-demand content application 408 also creates a bookmark 422 in the short-term content buffer, or the bookmark 422 references to the video content in the short-term content buffer, to indicate when during the first video content the viewer requested that the movie display be fast-advanced. The bookmark 422 can be created within the short-term content buffer 416 itself and maintained as part of the first video content segment that it identifies, or is otherwise associated with. The bookmark 422 can also be created as an indication point within the video content, or as any number and type of indicators or identifiers, such as flags, data bits, and the like. Further, the bookmark 422 can be created as a data structure that references to a position in the content buffer 416, but is maintained separately.

When the viewer finishes watching the end of the movie, the viewer can return to the point in the video content from which the fast-advance was initiated before the point is written over in the short-term content buffer 416 (e.g., within thirty minutes if the short-term content buffer is a thirty minute pause buffer, for example). The viewer can resume watching the first video content from the fast-advance point identified by bookmark 422. Alternatively, the viewer can playback the recording 418 of the movie at a later time which will have been recorded in its entirety without interruption and without a change in the speed at which the first video content stream is recorded.

Method for Fast-Advance While Recording On-Demand Content

A method for fast-advancing a display of on-demand content while recording the on-demand content may be described in the general context of computer-executable instructions. Generally, computer-executable instructions include routines, programs, objects, components, data structures, and the like that perform particular functions or implement particular abstract data types. The described method may also be practiced in distributed computing environments where functions are performed by remote processing devices that are linked through a communications network. In a distributed computing environment, computer-executable instructions may be located in both local and remote computer storage media, including memory storage devices.

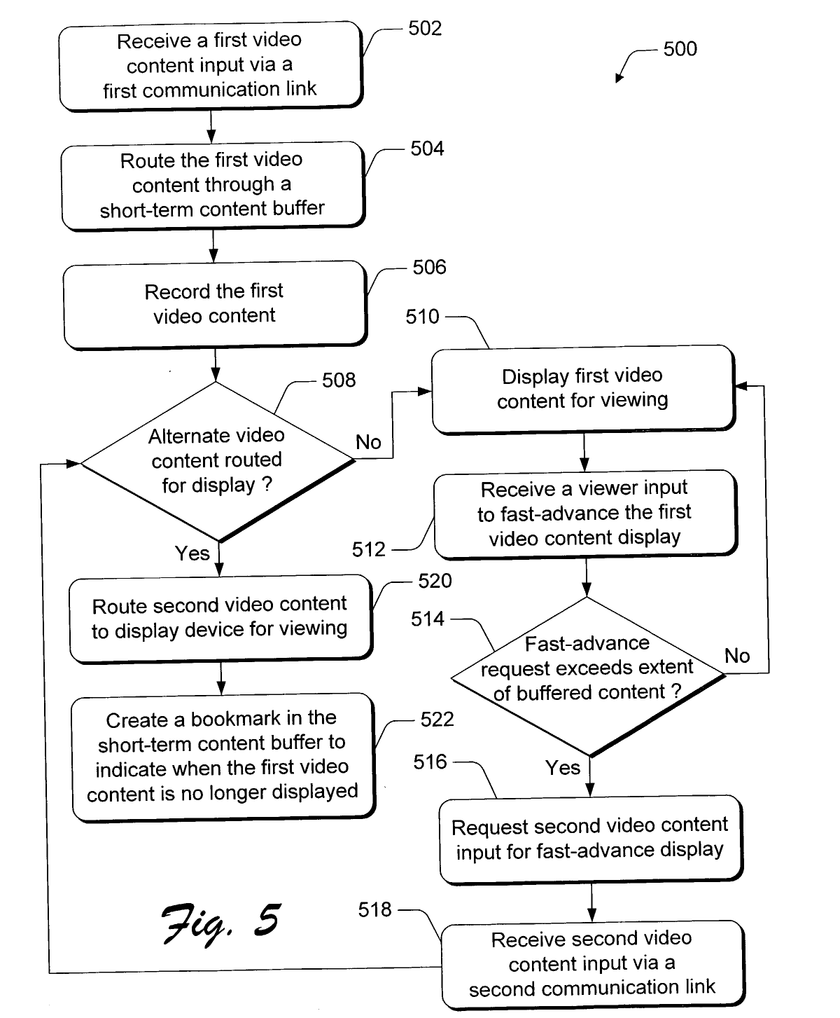

FIG. 5 illustrates a method 500 for fast-advancing a display of on-demand content while recording the on-demand content. The order in which the method is described is not intended to be construed as a limitation, and any number of the described method blocks can be combined in any order to implement the method. Furthermore, the method can be implemented in any suitable hardware, software, firmware, or combination thereof.

At block 502, a first video content input is received via a first communication link. For example, tuner 410 in digital video recorder 402 receives on-demand video content, which can be received as a stream of video content, from the video on-demand content server 404 via the broadcast network 110 (FIG. 4). At block 504, the first video content is routed through a short-term content buffer. For example, short-term content buffer 416 in digital video recorder 402 receives the first video content and maintains segments of the first video content, such as the most recent thirty minutes, for example.

At block 506, the first video content is recorded. For example, the first video content is routed from the short-term content buffer 416 in digital video recorder 402 to generate recorded content 418 (i.e., a recording of the first video content) in disk drive 412. At block 508, a determination is made as to whether alternate video content is routed for display. If alternate video content is not routed for display in digital video recorder 402, for example (i.e., “no” from block 508), the first video content is displayed for viewing at block 510. For example, the first video content is routed from the short-term content buffer 416 in digital video recorder 402 to the audio/video output component 414 and to display device 406.

At block 512, a viewer input to fast-advance the first video content display is received. A viewer request to fast-advance the first video content can include fast-forwarding the video content or fast-rewinding the video content. At block 514, a determination is made as to whether the fast-advance request exceeds the extent of the buffered content. For example, if the viewer request to fast-advance the first video content is within the segment of the video content currently maintained in short-term content buffer 416, then the first video content recording will not be interrupted and the speed of the recording will not be changed due to the buffered content delay. If the fast advance request does not exceed the extent of the buffered content (i.e., “no” from block 514), the first video content continues to be displayed for viewing at block 510.

If the fast advance request does exceed the extent of the buffered content (i.e., “yes” from block 514), a second video content input is requested for fast-forward or fast-rewind display at block 516. For example, on-demand content application 408 in digital video recorder 402 receives the fast-advance request (e.g., viewer input) and requests a second input of the same video content from the video on-demand content server 404. The on-demand content application 408 can request that the second video content be provided at a particular channel frequency, such as at the same channel frequency that the first video content is received.

At block 518, the second video content input is received via a second communication link that is separate from which the first video content is received. For example, digital video recorder 402 receives the second video content input from the video on-demand content server 404 via back channel 134. When the second video content input is received (block 518), the method returns to determine whether alternate video content is routed for display (block 508).

If alternate video content is routed for display in digital video recorder 402, for example (i.e., “yes” from block 508), the second video content (i.e., the alternate content) is routed for display at block 520. When digital video recorder 402 receives the second video content at the same channel frequency that the first video content is received, the second video content is routed in digital video recorder 402 to the audio/video output component 414 and to display device 406. Although the first video content is no longer displayed, the first video content is still received via broadcast network 110 and is still being recorded without interruption.

At block 522, a bookmark is created in the short-term content buffer to indicate when the first video content is no longer displayed. For example, the on-demand content application 408 creates a bookmark 422 in the short-term content buffer 416 in digital video recorder 402 to indicate when during the first video content the viewer requested that the video content be fast-advanced. Providing that the viewer returns to the point in the video content from which the fast-advance was initiated before the point is written over in the short-term content buffer (e.g., within thirty minutes if the short-term content buffer is a thirty minute pause buffer, for example), the viewer can resume watching the first video content from the fast-advance point identified by bookmark 422.

Conclusion

Although the invention has been described in language specific to structural features and/or methods, it is to be understood that the invention defined in the appended claims is not necessarily limited to the specific features or methods described. Rather, the specific features and methods are disclosed as preferred forms of implementing the claimed invention.

1. A digital video recording system, comprising:
a tuner configured to receive a first stream of on-demand content;
a recording component configured to record the first stream of the on-demand content;
an on-demand content application configured to:
route the first stream of the on-demand content for display;
receive a request to fast advance the on-demand content display;
request a second stream of the on-demand content; and
route the second stream of the on-demand content for fast-advance display to replace the first stream of the on-demand content display:

2. A digital video recording system as recited in claim 1, further comprising a short-term content buffer configured to maintain segments of the first stream of the on-demand content before the segments are recorded.

3. A digital video recording system as recited in claim 1, wherein the on-demand content application is further configured to route the first stream of the on-demand content through a short-term content buffer before the first stream of the on-demand content is recorded.

4. A digital video recording system as recited in claim 1, wherein the on-demand content application is further configured to route the first stream of the on-demand content through a short-term content buffer, and create a bookmark in the short-term content buffer to indicate when the first stream of the on-demand content is replaced on the display.

5. A digital video recording system as recited in claim 1, wherein the memory component is further configured to record the first stream of the on-demand content without interruption.

6. A digital video recording system as recited in claim 1, wherein the memory component is further configured to record the first stream of the on-demand content without a change in the speed at which the first stream of the on-demand content is recorded.

7. A digital video recording system as recited in claim 1, wherein the on-demand content application is further configured to receive the second stream of the on-demand content at a channel frequency that the first stream of the on-demand content is received.

8. A digital video recording system as recited in claim 1, wherein the on-demand content application is further configured to request the second stream of the on-demand content at a particular channel frequency.

9. A digital video recording system as recited in claim 1, wherein the on-demand content application is further configured to receive the second stream of the on-demand content via a separate communication link from which the first stream of the on-demand content is received.

10. A television-based entertainment system comprising the digital video recording system as recited in claim 1.

11. A computing device comprising the digital video recording system as recited in claim 1.

12. A client device, comprising:
a tuner configured to receive a first video content input from a content provider via a communication link;
a recording component configured to record the first video content while the first video content is displayed;
an application component configured to:
receive a viewer input to fast-forward the first video content display;
request a second video content input for fast-forward display;
receive the second video content input from the content provider via a second communication link; and
route the second video content for display instead of the first video content while the first video content is recorded.

13. A client device as recited in claim 12, further comprising a short-term content buffer configured to receive segments of the first video content before the segments are recorded.

14. A client device as recited in claim 12, wherein the application component is further configured to route the first video content input through a short-term content buffer before the first video content is recorded.

15. A client device as recited in claim 12, wherein the application component is further configured to route the first video content input through a short-term content buffer, and create a bookmark in the short-term content buffer to indicate when the first video content is no longer routed for display.

16. A client device as recited in claim 12, wherein the recording component is further configured to record the first video content without interruption when the viewer input is received and when the second video content input is received.

17. A client device as recited in claim 12, wherein the recording component is further configured to record the first video content without a change in the speed at which the first video content is recorded.

18. A client device as recited in claim 12, wherein the application component is further configured to receive the second video content input at the same channel frequency that the first video content input is received.

19. A client device as recited in claim 12, wherein the application component is further configured to request the second video content input be provided at a particular channel frequency.

20. A digital video recording system comprising the client device as recited in claim 12.

21. A method, comprising:
displaying a first stream of on-demand content for viewing;
recording the first stream of the on-demand content;
receiving a request to fast-advance displaying the on-demand content;
requesting a second stream of the on-demand content;
fast-advancing the second stream of the on-demand content; and
displaying the second stream of the on-demand content for viewing instead of the first stream of the on-demand content.

22. A method as recited in claim 21, wherein receiving the request includes receiving a viewer input for fast-forward displaying the on-demand content while continuing recording the first stream of the on-demand content.

23. A method as recited in claim 21, wherein receiving the request includes receiving a viewer input for fast-rewind displaying the on-demand content while continuing recording the first stream of the on-demand content.

24. A method as recited in claim 21, further comprising routing the first stream of the on-demand content through a short-term content buffer before recording the first stream of the on-demand content.

25. A method as recited in claim 21, further comprising routing the first stream of the on-demand content through a short-term content buffer, and creating a bookmark in the short-term content buffer to indicate when the first stream of the on-demand content is no longer displayed.

26. A method as recited in claim 21, wherein recording includes recording the first stream of the on-demand content without interruption.

27. A method as recited in claim 21, wherein recording includes recording the first stream of the on-demand content without a change in the speed at which the first stream of the on-demand content is recorded.

28. A method as recited in claim 21, further comprising receiving the second stream of the on-demand content at a channel frequency that the first stream of the on-demand content is received.

29. A method as recited in claim 21, wherein requesting includes requesting the second stream of the on-demand content at a particular channel frequency.

30. A method as recited in claim 21, further comprising receiving the second stream of the on-demand content via a separate communication link from which the first stream of the on-demand content is received.

31. One or more computer-readable media comprising computer-executable instructions that, when executed, direct a digital video recording system to perform the method of claim 21.

32. One or more computer-readable media comprising computer-executable instructions that, when executed, direct a computing device to perform the method of claim 21.

33. A method, comprising:
displaying a first stream of on-demand content for viewing;
recording the first stream of the on-demand content;
receiving a request to fast-advance displaying the on-demand content; and
determining whether to request a second stream of the on-demand content for a fast-advance display of the on-demand content.

34. A method as recited in claim 33, further comprising:
requesting the second stream of the on-demand content; and
displaying the second stream of the on-demand content for viewing instead of the first stream of the on-demand content.

35. A method as recited in claim 33, wherein determining includes determining whether the request to fast-advance the first stream of the on-demand content exceeds a buffered segment of the first stream of the on-demand content.

36. A method as recited in claim 33, further comprising:
requesting the second stream of the on-demand content; and
displaying the second stream of the on-demand content for viewing instead of the first stream of the on-demand content if the request to fast-advance the first stream of the on-demand content exceeds a buffered segment of the first stream of the on-demand content.

37. A method as recited in claim 33, wherein receiving the request includes receiving a viewer input for fast-forward displaying the on-demand content while continuing recording the first stream of the on-demand content.

38. A method as recited in claim 33, wherein receiving the request includes receiving a viewer input for fast-rewind displaying the on-demand content while continuing recording the first stream of the on-demand content.

39. A method as recited in claim 33, further comprising routing the first stream of the on-demand content through a short-term content buffer before recording the first stream of the on-demand content.

40. A method as recited in claim 33, further comprising routing the first stream of the on-demand content through a short-term content buffer, and creating a bookmark in the short-term content buffer to indicate the fast-advance request.

41. A method as recited in claim 33, wherein recording includes recording the first stream of the on-demand content without a change in the speed at which the first stream of the on-demand content is recorded.

42. A method as recited in claim 33, further comprising requesting the second stream of the on-demand content at a particular channel frequency if the request to fast-advance the first stream of the on-demand content exceeds a buffered segment of the first stream of the on-demand content.

43. A method as recited in claim 33, further comprising receiving the second stream of the on-demand content via a separate communication link from which the first stream of the on-demand content is received.

44. One or more computer-readable media comprising computer-executable instructions that, when executed, direct a digital video recording system to perform the method of claim 33.

45. One or more computer-readable media comprising computer-executable instructions that, when executed, direct a computing device to perform the method of claim 33.

46. A video recording system, comprising:
means for receiving a first video content input via a first communication link;
means for recording the first video content while the first video content is routed for display;
means for receiving a viewer input to fast-forward the first video content display;
means for requesting a second video content input for fast-forward display;
means for receiving the second video content input via a second communication link; and
means for routing the second video content for display instead of the first video content while the first video content is recorded.

47. A video recording system as recited in claim 46, further comprising means for routing the first video content input through a short-term content buffer before the first video content is recorded.

48. A video recording system as recited in claim 46, further comprising means for receiving the second video content input at the same channel frequency that the first video content input is received.

49. A video recording system as recited in claim 46, further comprising means for requesting that the second video content input be provided at a particular channel frequency.

50. One or more computer-readable media comprising computer-executable instructions that, when executed, direct a client device of a video on-demand system to:
receive a first video content input via a communication link from a content provider;
record the first video content while displaying the first video content;
receive a viewer input to fast-forward the displaying first video content;
request a second video content input for fast-forward display;
receive the second video content input via a second communication link from the content provider; and
route the second video content for display instead of the first video content while the first video content is recorded.

51. One or more computer-readable media as recited in claim 50, further comprising computer executable instructions that, when executed, direct the client device of the video on-demand system to maintain segments of the first video content in a short-term content buffer before the segments are recorded.

52. One or more computer-readable media as recited in claim 50, further comprising computer executable instructions that, when executed, direct the client device of the video on-demand system to route the first video content input through a short-term content buffer before the first video content is recorded.

53. One or more computer-readable media as recited in claim 50, further comprising computer executable instructions that, when executed, direct the client device of the video on-demand system to route the first video content input through a short-term content buffer, and create a bookmark in the short-term content buffer to indicate when the first video content is no longer routed for display.

54. One or more computer-readable media as recited in claim 50, further comprising computer executable instructions that, when executed, direct the client device of the video on-demand system to record the first video content without interruption when the viewer input is received and when the second video content input is received.

55. One or more computer-readable media as recited in claim 50, further comprising computer executable instructions that, when executed, direct the client device of the video on-demand system to receive the second video content input at the same channel frequency that the first video content input is received.

56. One or more computer-readable media as recited in claim 50, further comprising computer executable instructions that, when executed, direct the client device of the video on-demand system to request the second video content input be provided at a particular channel frequency.
